(19) United States
(12) Patent Application Publication
(10) Pub. No.: US 2026/0269991 A1
(43) Pub. Date: Sep. 10, 2026

(54) DATA TRANSMISSION METHOD, COMMUNICATION DEVICE AND STORAGE MEDIUM

(71) Applicant: ZTE CORPORATION, Shenzhen, Guangdong (CN)

(72) Inventors: Jian HUA, Shenzhen (CN); Yu XIN, Shenzhen (CN); Tong BAO, Shenzhen (CN)

(21) Appl. No.: 19/165,721

(22) PCT Filed: Feb. 23, 2024
(86) PCT No.: PCT/CN2024/078283

§ 371 Date: Sep. 16, 2025

(30) Foreign Application Priority Data
May 25, 2023 (CN) 202310606626.6

(51) Int. Cl. H04L 5/00; H04L 1/00; H04L 27/26

(52) U.S. Cl. CPC H04L 5/0005; H04L 1/0061; H04L 27/26025

(57) ABSTRACT

The present disclosure provides a data transmission method, including: dividing data to be transmitted into N first sequences; where the N first sequences correspond to different sub-bands, and a number of pieces of data of each of M first sequences in the N first sequences is less than a number of subcarriers of a corresponding sub-band; obtaining N third sequences based on the N first sequences; where M third sequences in the N third sequences are obtained by performing a Fourier transform, and then performing a cyclic repetition or zero padding operation on the M first sequences, respectively; a number of pieces of data of each of the N third sequences is equal to a number of subcarriers of a corresponding sub-band; obtaining a data sequence based on the N third sequences; transmitting the data sequence on a time-frequency resource corresponding to the data to be transmitted.

### CROSS-REFERENCE TO RELATED APPLICATION(S)

The present disclosure is a national phase entry under 35 USC 371 of International Patent Application No. PCT/CN2024/078283 filed on Feb. 23, 2024, the International Patent Application is filed based on Chinese Patent Application with the application No. 202310606626.6, filed on May 25, 2023, and claims priority to the Chinese Patent Application, the entire contents of the International Patent Application and the Chinese Patent Application are incorporated herein by reference.

### TECHNICAL FIELD

The present disclosure relates to the field of communication technologies, and particularly to a data transmission method, a data transmission apparatus, and a storage medium.

### BACKGROUND

The orthogonal frequency division multiplexing (Orthogonal Frequency Division Multiplexing, OFDM) technology is an efficient digital modulation technology, that is often used in wireless communication systems. This technology splits a high-speed data stream into multiple low-speed sub-channels, and each of the sub-channels uses a different sine wave frequency as a carrier, to form a group of orthogonal subcarriers on the carrier frequency. These orthogonal carriers are independent of each other and do not interfere with each other, so that an OFDM system may tolerate channel interference problems such as multi-path effects and frequency selective fading, etc.

### SUMMARY

In an aspect, a data transmission method is provided. The data transmission method includes:

dividing data to be transmitted into N first sequences; where the N first sequences correspond to different sub-bands, a number of pieces of data of each of M first sequences in the N first sequences is less than a number of subcarriers of a corresponding sub-band, N is a positive integer, and M is a positive integer less than or equal to N;

obtaining N third sequences based on the N first sequences; where M third sequences in the N third sequences are obtained by performing a Fourier transform, and then performing a cyclic repetition or zero padding operation on the M first sequences, respectively; a number of pieces of data of each of the N third sequences is equal to a number of subcarriers of a corresponding sub-band;

obtaining a data sequence based on the N third sequences;

transmitting the data sequence on a time-frequency resource corresponding to the data to be transmitted.

In another aspect, a data transmission apparatus is provided. The data transmission apparatus includes:

a processing module, configured to divide data to be transmitted into N first sequences; where the N first sequences correspond to different sub-bands, a number of pieces of data of each of M first sequences in the N first sequences is less than a number of subcarriers of a corresponding sub-band, N is a positive integer, and M is a positive integer less than or equal to Ndata;

the processing module, further configured to obtain N third sequences based on the N first sequences; where M third sequences in the N third sequences are obtained by performing a Fourier transform, and performing a cyclic repetition or zero padding operation on the M first sequences, respectively; a number of pieces of data of each of the N third sequences is equal to a number of subcarriers of a corresponding sub-band;

the processing module, further configured to obtain a data sequence based on the N third sequences;

a communication module, configured to transmit the data sequence on a time-frequency resource corresponding to the data to be transmitted.

In yet another aspect, a communication apparatus is provided. The communication apparatus includes: a memory and a processor; the memory is coupled with the processor; the memory is configured to store computer program instructions executable by the processor; the processor, when executing the computer program instructions, implements the data transmission method described in any one of the above aspects or embodiments.

In yet another aspect, a computer-readable storage medium is provided. The computer-readable storage medium stores computer program instructions, and the computer program instructions, when executed on a computer (for example, a communication apparatus or a data transmission apparatus), implement the data transmission method described in any one of the above aspects or embodiments.

In yet another aspect, a computer program product is provided. The computer program product includes computer program instructions, and the computer program instructions, when executed, implement the data transmission method described in any one of the above aspects or embodiments.

### BRIEF DESCRIPTION OF THE DRAWINGS

FIG. 1 is a schematic diagram of an architecture of a communication system according to some embodiments.

FIG. 2 is a flowchart of a data transmission method according to some embodiments.

FIG. 3 is a schematic diagram of a process of a data transmission according to some embodiments.

FIG. 4 is a schematic diagram of a process of another data transmission according to some embodiments.

FIG. 5 is a schematic diagram of a process of yet another data transmission according to some embodiments.

FIG. 6 is a schematic diagram of a process of yet another data transmission according to some embodiments.

FIG. 7 is a schematic diagram of a process of yet another data transmission according to some embodiments.

FIG. 8 is a schematic diagram of a process of yet another data transmission according to some embodiments.

FIG. 9 is a schematic diagram of a process of yet another data transmission according to some embodiments.

FIG. 10 is a schematic diagram of a process of yet another data transmission according to some embodiments.

FIG. 11 is a schematic diagram of a process of yet another data transmission according to some embodiments.

FIG. 12 is a structural schematic diagram of a data transmission apparatus according to some embodiments.

FIG. 13 is a structural schematic diagram of a communication apparatus according to some embodiments.

### DETAILED DESCRIPTION

The technical solutions in the embodiments of the present disclosure will be described clearly and completely below in conjunction with the drawings in the embodiments of the present disclosure. It is obvious that the described embodiments are only a part of the embodiments of the present disclosure, but not all of the embodiments. Based on the embodiments in the present disclosure, all other embodiments obtained by those ordinary skilled in the art without creative efforts shall fall within the protection scope of the present disclosure.

In the description of the present disclosure, unless otherwise stated, the character “/” means “or”, and for example, “A/B” may mean A or B. Herein, “and/or” is merely an association relationship for describing associated objects, which represents that there may be three kinds of relationships, for example, ‘A and/or B’ may represent: only A, only B, or both A and B. In addition, “at least one” means one or more, and “a/the plurality of/multiple” means two or more. The words “first” and “second”, etc., do not limit the quantity and execution order, and the words “first” and “second” and the like are not necessarily used to limit the different items.

It should be noted that, in the present disclosure, the words such as “exemplary/exemplarily” or “for example (e.g., such as)” are used to present an example, illustration, or explanation. Any embodiment or design scheme described with “exemplary/exemplarily” or “for example (e.g., such as)” in the present disclosure should not be construed as preferred or advantageous over other embodiments or design schemes. Rather, the usage of the words, such as “exemplary/exemplarily” or “for example (e.g., such as)”, etc., is intended to present relevant concepts in a specific mode.

The Long Term Evolution (LTE) technology is a wireless cellular communication technology for Fourth Generation (4G) communication networks. LTE uses orthogonal frequency division multiplexing technology, and time-frequency resources composed of subcarriers and OFDM symbols constitute radio physical time-frequency resources of the LTE system.

Currently, the OFDM technology has been widely applied in wireless communications. Due to the use of cyclic prefixes (Cyclic Prefix, CP), the CP-OFDM system can greatly solve multi-path delay problems, and divide frequency selective channels into a set of parallel flat channels, which greatly simplifies the channel estimation method and provides high channel estimation accuracy. However, the performance of a CP-OFDM system is relatively sensitive to a frequency offset and a time offset between adjacent sub-bands, mainly due to the large frequency spectrum leakage of the system, which easily results in interference between sub-bands. The LTE system uses a guard interval in the frequency domain, but this reduces frequency spectrum efficiency, so new technologies are needed to suppress out-of-band leakage.

Fifth Generation New Radio (5G NR) communication technologies still use CP-OFDM as the basic waveform, and different subcarrier spacing Numerologies may be used between two adjacent sub-bands, which will destroy the orthogonality between subcarriers and bring a new interference problem. One of the more direct methods to solve this interference problem is to insert a protection bandwidth between two transmission bands with different Numerologies, but this will waste frequency resources.

With the development of the technologies, frequency bands used by future 6G communication network traffics span a wide range, and deployment modes thereof also increase. This will not only require multi-bandwidth channels, but also require waveform solutions that meet different scenarios. Implementing each waveform solution independently will increase the cost of base stations and terminals. The issues that need to be addressed are how to design a unified waveform architecture that flexibly merges multiple waveforms, and how to flexibly support applications on different channel bandwidths, to flexibly configure different sub-bands to adapt to different channel conditions, and to improve frequency spectrum efficiency.

In view of this, the present disclosure provides a data transmission method including: dividing data to be transmitted into N first sequences; where the N first sequences correspond to different sub-bands, a number of pieces of data of each of M first sequences in the N first sequences is less than a number of subcarriers of a corresponding sub-band, N is a positive integer, and M is a positive integer less than or equal to Ndata; obtaining N third sequences based on the N first sequences, where M third sequences in the N third sequences are obtained by performing a Fourier transform, and then performing a cyclic repetition or zero padding operation on the M first sequences, respectively, a number of pieces of data of each of the N third sequences is equal to a number of subcarriers of a corresponding sub-band; obtaining a data sequence based on the N third sequences; and transmitting the data sequence on a time-frequency resource corresponding to the data to be transmitted. In this way, for the M first sequences with the number of pieces of data less than the number of subcarriers of the corresponding sub-band, a Fourier transform, and then a cyclic repetition or zero padding operation is performed on it, so that the number of pieces of data contained in each first sequence of the M first sequences is equal to the number of subcarriers of its corresponding sub-band, which is conducive to reducing out-of-band leakage, reducing guard intervals, and improving frequency spectrum efficiency. In addition, it may more flexibly support multi-bandwidth channels and support a variety of waveforms.

The technical solutions provided by the embodiments of the present disclosure may be applied to various mobile communication networks, for example, New Radio (NR) mobile communication networks using the 5th generation mobile communication technology (5G), future mobile communication networks, or multi-communication technology fusion systems, etc., which is not limited in the embodiments of the present disclosure.

The network architecture of the mobile communication networks (including but not limited to 3G, 4G, 5G, and future mobile communication networks) in the embodiments of the present disclosure may include a first communication node and a second communication node. In some examples, the first communication node may be a base station, and the second communication node may be a terminal. In other examples, the first communication node may be a terminal, and the second communication node may be a base station. In yet other examples, in a device-to-device communication scenario, the first communication node and the second communication node may both be terminals. The embodiments of the present disclosure are not limited thereto.

Exemplarily, taking an example in which the first communication node is the base station and the second communication node is the terminal, FIG. 1 shows a schematic diagram of an architecture of a communication system provided in the embodiments of the present disclosure. As shown in FIG. 1, the communication system 10 includes a plurality of base stations (e.g., base station 21 and base station 22) and a plurality of terminals (e.g., terminal 31, terminal 32, terminal 33, and terminal 34). The plurality of base stations and the plurality of terminals may be in communication connections.

Exemplarily, taking an example in which the network side device is the base station and the receiving side device is the terminal, FIG. 1 shows a schematic diagram of an architecture of a communication system provided in the embodiments of the present disclosure. As shown in FIG. 1, the communication system 10 includes a plurality of base stations (e.g., base station 21 and base station 22) and a plurality of terminals (e.g., terminal 31, terminal 32, terminal 33, and terminal 34). The plurality of base stations and the plurality of terminals may be in communication connections.

In some embodiments, the base station is used to provide radio access services to a plurality of terminals. For example, a base station provides at least one service coverage area (which may also be referred to as a cell). Terminals entering this area may communicate with the base station via wireless signals, to accept the radio access services provided by the base station. There may be an overlap between service coverage areas of the base stations, and a terminal located in an overlapped area may receive wireless signals from the plurality of base stations.

In some embodiments, the base station may connect to a plurality of terminal devices, for example, base station 21 connects to terminal 31 and terminal 32. Terminal 31 and terminal 32 may be located in a same cell, or terminal 31 and terminal 32 may be located in different cells. That is, a base station may provide network services to terminals in a cell, or may provide network services to terminals in a plurality of cells at the same time.

In some embodiments, the base station may be a base station in LTE, long term evolution advanced (LTEA), or an evolutional base station (evolutional node B, eNB or eNodeB), a base station in the 5G network, or a base station in future communication systems, and so on, and the base station may include various base stations, micro base stations, home base stations, remote radio device, reconfigurable intelligent surfaces (RIS), routers, wireless fidelity (WIFI) devices, or various network side devices such as primary cells and secondary cells, etc.

In some embodiments, the terminal may be a device with a wireless transceiver function, which may be deployed on land (including indoor or outdoor, handheld, worn, or vehicle-mounted); may be deployed on water (e.g., a ship, etc.); or may also be deployed in the air (e.g., an airplane, a balloon, a satellite, etc.). The terminal may be a mobile phone, a tablet computer (Pad), a computer with a wireless transceiver function, a virtual reality (VR) terminal, an augmented reality (AR) terminal, a wireless terminal in industrial control, a wireless terminal in self driving, a wireless terminal in remote medical, a wireless terminal in smart grid, a wireless terminal in transportation safety, a wireless terminal in smart city, a wireless terminal in smart home, etc. The embodiments of the present disclosure do not limit the application scenarios. The terminal sometimes may also be referred to as a user, user equipment (UE), access terminal, UE unit, UE station, mobile station, mobile platform, remote station, remote terminal, mobile device, UE terminal, wireless communication device, UE agent, UE apparatus, etc., which is not limited to the embodiments of the present disclosure.

It should be noted that FIG. 1 is only an exemplary framework diagram, and the number of devices and the names of the respective devices included in FIG. 1 are not limited, and in addition to the devices shown in FIG. 1, the communication system may also include other devices, such as a core network device.

The application scenarios for the embodiments of the present disclosure are not limited. The system architectures and service scenarios described in the embodiments of the present disclosure are intended to more clearly illustrate the technical solutions of the embodiments of the present disclosure, and do not limit the technical solutions provided in the embodiments of the present disclosure, and those ordinary skilled in the art may know that with the evolution of the network architectures and the emergence of new service scenarios, the technical solutions provided in the embodiments of the present disclosure may also be applicable for similar technical problems.

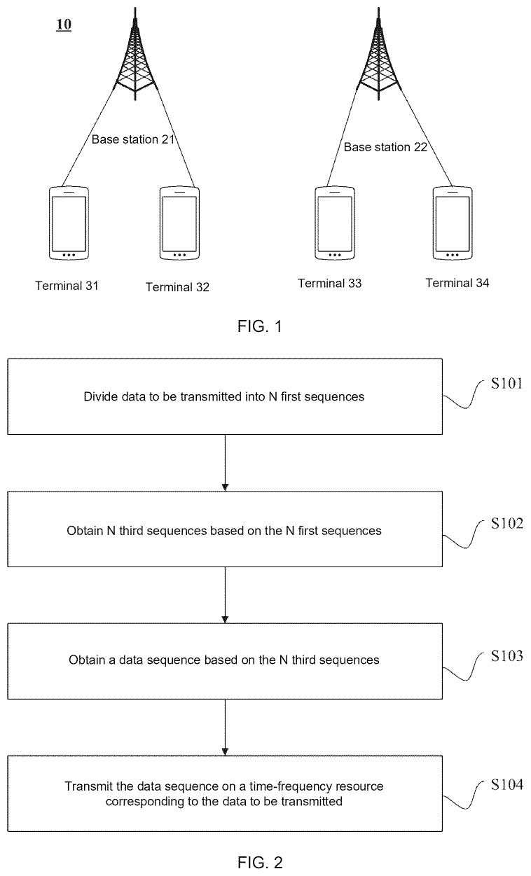

The embodiments of the present disclosure provide a data transmission method, which is applicable to a first communication node. As shown in FIG. 2, the method includes the following steps.

S101, divide data to be transmitted into N first sequences.

The N first sequences correspond to different sub-bands, a number of pieces of data of each of M first sequences in the N first sequences is less than a number of subcarriers of a corresponding sub-band, N is a positive integer, and M is a positive integer less than or equal to N.

In some embodiments, the data to be transmitted is all or a part of data to be transmitted in a channel bandwidth.

In some embodiments, a different sub-band is allocated to each first sequence of the N first sequences, and a total of N sub-bands are allocated, i.e., the N first sequences correspond to N sub-bands. The N sub-bands include all or part of frequency domain resource blocks in the channel bandwidth, and each sub-band of the N sub-bands corresponds to a first sequence.

In some embodiments, the number of pieces of data in each of the N first sequences is less than the number of subcarriers in the corresponding sub-band. In this case, the above-mentioned M is equal to N. In this way, interference between all sub-bands is suppressed, thereby improving the overall performance.

In some embodiments, the numbers of pieces of data in the N first sequences are all the same. Alternatively, the numbers of pieces of data in the N first sequences are not all the same.

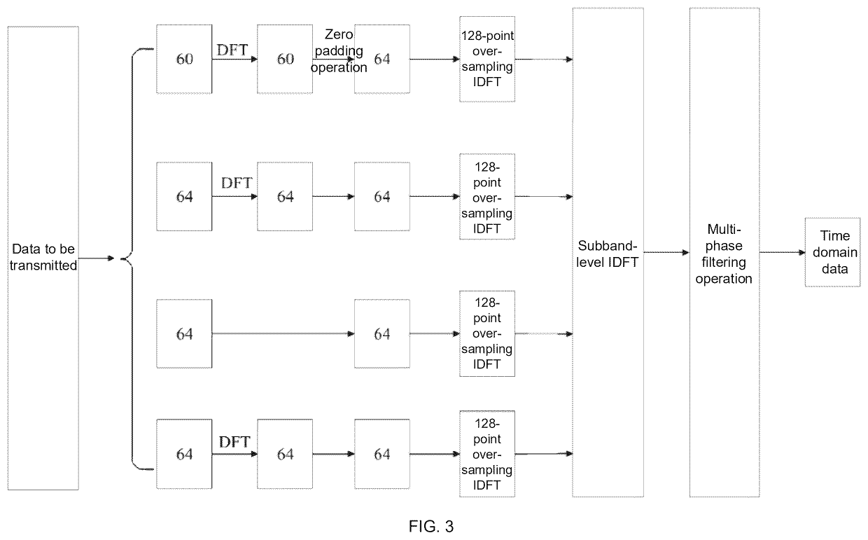

Exemplarily, as shown in FIG. 3, the data to be transmitted is divided into four first sequences, where the 1st first sequence contains 60 pieces of data, and each first sequence of the 2nd, 3rd, and 4th first sequences contains 64 pieces of data.

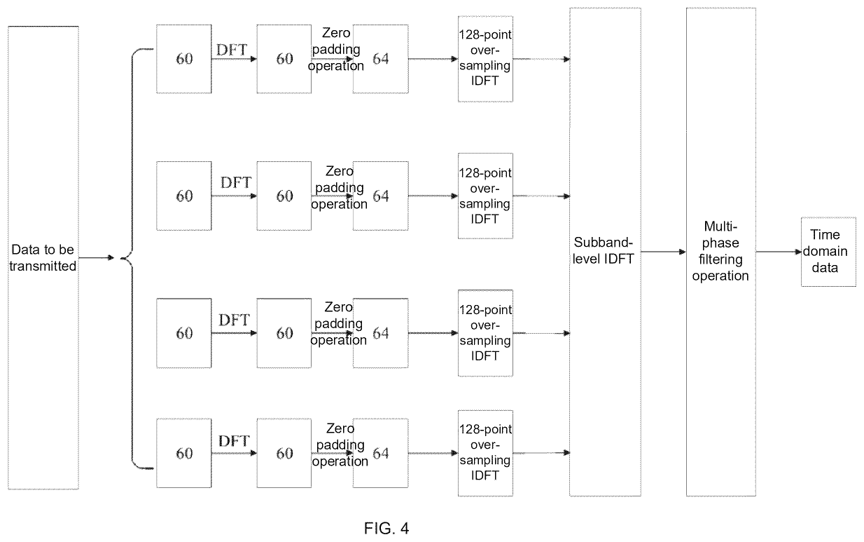

Yet exemplarily, as shown in FIG. 4, the data to be transmitted is divided into four first sequences, and each of the first sequences contains 60 pieces of data. The number of subcarriers of a sub-band corresponding to each first sequence of the four first sequences is 64, i.e., the number of pieces of data of each of the four first sequences is less than the number of subcarriers of the corresponding sub-band.

In some embodiments, the numbers of pieces of data of the M first sequences are all the same. Alternatively, the numbers of pieces of data of the M first sequences are not all the same. This is conducive to flexibly configuring the number of pieces of data within the sub-bands.

Exemplarily, continuing to refer to FIG. 4, the number of pieces of data of each of the four first sequences is less than the number of subcarriers in the corresponding sub-band, and the numbers of pieces of data of the four first sequences are all the same.

In some embodiments, the data to be transmitted includes constellation point modulated data and also includes R pieces of reference signal data, where R is a positive integer. The constellation point modulated data is used to transmit user data, and the reference signal data is used to help the receiving end measure the channel state, perform channel estimation, and decode. By using the reference signal data, the receiving end may more accurately demodulate and decode signals, thereby improving the reliability and performance of the communication.

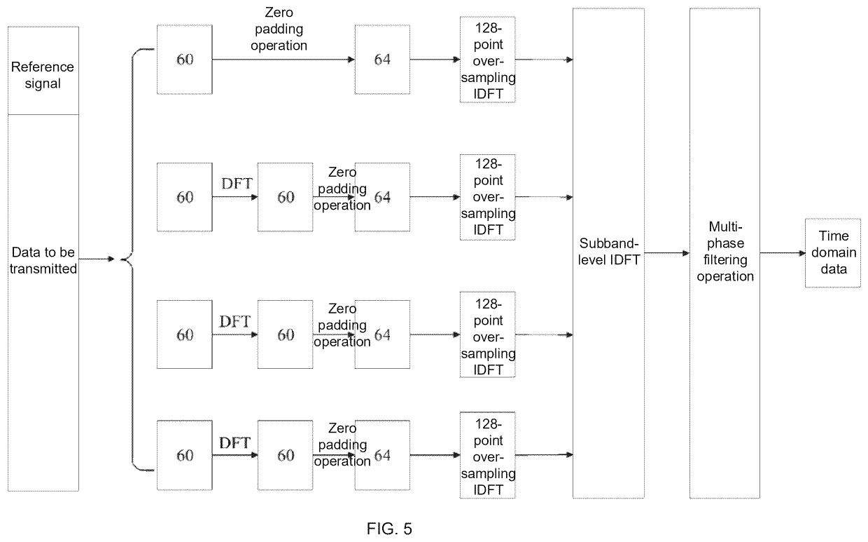

Exemplarily, as shown in FIG. 5, the data to be transmitted and a reference signal are divided into four first sequences, and each first sequence in four first sequence contains 60 pieces of data. Data contained in the 1st sequence is reference signal data.

In some embodiments, the N first sequences are transmitted in a single carrier mode. In this way, when the N first sequences are transmitted by using a single carrier, less power and energy are required, which may effectively reduce the power consumption and energy consumption of the sending end and the receiving end.

In some embodiments, the M first sequences are transmitted in a single carrier mode, and other N-M first sequences except for the M first sequences in the N first sequences are transmitted in a multi-carrier mode. In this way, when transmitted in the multi-carrier mode, the first sequences may be transmitted on different carriers, thereby reducing the risk of a failure of a single carrier and improving the reliability and fault tolerance of the system.

Exemplarily, continuing to refer to FIG. 5, the 1st sequence may be transmitted in the single carrier mode or in the multi-carrier mode. If transmitted in the single carrier mode, zero padding operation is not performed, and the number of pieces of data contained in the 1st sequence is equal to the number of subcarriers of its corresponding sub-band. The figure selects the case of being transmitted in the multi-carrier mode.

In some embodiments, the numbers of subcarriers of sub-bands corresponding to the N first sequences are the same, and subcarrier spacings of sub-bands corresponding to the N first sequences are the same.

Exemplarily, continuing to refer to FIG. 3, the data to be transmitted is divided into four first sequences, the 1st first sequence contains 60 pieces of data, and each first sequence of the 2nd, 3rd, and 4th first sequences contains 64 pieces of data. The number of subcarriers of a sub-band corresponding to each first sequence of the four first sequences is 64, and the subcarrier spacing of a sub-band corresponding to each first sequence of the four first sequences is 15 KHz.

Yet exemplarily, continuing to refer to FIG. 4, the data to be transmitted is divided into four first sequences, each of the first sequences contains 60 pieces of data. The number of subcarriers of a sub-band corresponding to each first sequence of the four first sequences is 64, and the subcarrier spacing of a sub-band corresponding to each first sequence of the four first sequences is 15 KHz.

In some embodiments, the numbers of subcarriers of the sub-bands corresponding to the N first sequences are not all the same; where subcarrier spacings of two sub-bands with a same number of subcarriers are the same; and subcarrier spacings of two sub-bands with different numbers of subcarriers are different.

In some embodiments, for the two sub-bands with different numbers of subcarriers, a ratio value between the numbers of subcarriers of the two sub-bands is 2 to a power of i, and a ratio value between the subcarrier spacings of the two sub-bands is 2 to a power of −i, where i is an integer. This may ensure that sub-bands with different subcarrier spacings may transmit data together within the same frequency band.

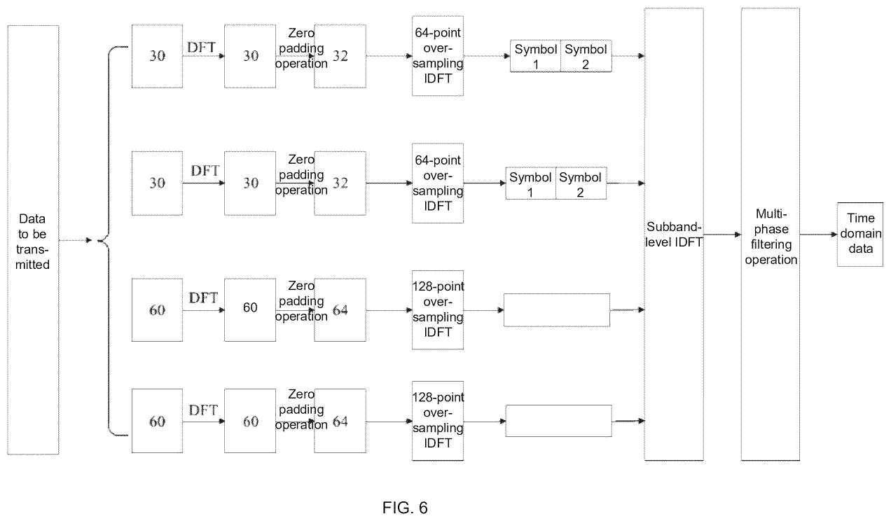

Exemplarily, as shown in FIG. 6, the data to be transmitted is divided into four first sequences, where the 1st and 2nd first sequences both contain 30 pieces of data, and the 3rd and 4th first sequences both contain 60 pieces of data. The 1st and 2nd first sequences correspond to the numbers of subcarriers of sub-bands, as 32, respectively, and the carrier spacings are both 30 kHz. The 3rd and 4th first sequences correspond to the numbers of subcarriers of sub-bands, as 64, respectively, and the subcarrier spacings are both 15 kHz. Therefore, The number of subcarriers of the sub-band corresponding to the 1st first sequence or the 2nd first sequence is ½ times of the number of subcarriers of the sub-band corresponding to the 3rd first sequence or the 4th first sequence, and the subcarrier spacing of the sub-band corresponding to the 1st first sequence or the 2nd first sequence is 2 times of the subcarrier spacing of the sub-band corresponding to the 3rd first sequence or the 4th first sequence.

S102, obtain N third sequences based on the N first sequences.

M third sequences in the N third sequences are obtained by performing a Fourier transform, and then performing a cyclic repetition or zero padding operation on the M first sequences, respectively; a number of pieces of data of each of the N third sequences is equal to a number of subcarriers of a corresponding sub-band. The Fourier transform may decompose a signal in the time domain into a linear combination of sine waves and cosine waves with different frequencies and amplitudes. Exemplarily, the Fourier transform is a discrete Fourier transform (discrete fourier transform, DFT).

In some embodiments, for a first sequence with a number of pieces of data less than a number of subcarriers of a corresponding sub-band, a cyclic repetition or zero padding operation is performed on the first sequence, to obtain a third sequence.

Exemplarily, continuing to refer to FIG. 5, the data to be transmitted and a reference signal are divided into four first sequences, and each first sequence of the four first sequences contains 60 pieces of data. Data contained in the 1st sequence is reference signal data. Assuming that the 1st first sequence is [x1 x2 x3 . . . x59 x60], the zero padding operation is performed on the 1st first sequence, and the obtained third sequence is [0 0 x1 x2 x3 . . . x59 x60 0 0].

In other embodiments, for a first sequence with a number of pieces of data less than a number of subcarriers of a corresponding sub-band, a Fourier transform is performed on the first sequence to obtain a second sequence; a cyclic repetition or zero padding operation is performed on the second sequence to obtain a third sequence.

In some embodiments, performing the zero padding operation on the second sequence to obtain the third sequence, includes: determining a difference value Q between the number of subcarriers of the sub-band corresponding to the first sequence and the number of pieces of data included in the first sequence; in a case where Q is an even number, adding Q/2 pieces of data 0 at both ends of the second sequence respectively, to obtain the third sequence; in a case where Q is an odd number, adding (Q+1)/2 pieces of data 0 at a head end of the second sequence and adding (Q−1)/2 pieces of data 0 at a tail end of the second sequence, to obtain the third sequence; or adding (Q−1)/2 pieces of data 0 at a head end of the second sequence and adding (Q+1)/2 pieces of data 0 at a tail end of the second sequence, to obtain the third sequence.

Exemplarily, continuing to refer to FIG. 3, the number of pieces of data contained in the 1st first sequence is 60, and the number of subcarriers of the sub-band corresponding to the 1st first sequence is 64, so the difference value between the number of subcarriers of the sub-band corresponding to the 1st first sequence and the number of pieces of data contained in the first sequence is an even number 4. For example, it is assumed that the second sequence obtained by performing DFT on the 1st first sequence is [x1 x2 x3 . . . x59 x 60]. Then, two pieces of data 0 are added to both ends of the second sequence respectively, to obtain the third sequence corresponding to the 1st first sequence, which is [0 0 x1 x2 x3 . . . x59 x60 0 0].

Yet exemplarily, continuing to refer to FIG. 4, the data to be transmitted is divided into four first sequences, and each of the first sequences contains 60 pieces of data. The number of subcarriers of the sub-band corresponding to each first sequence of the four first sequences is 64, and the subcarrier spacing of the sub-band corresponding to each first sequence of the four first sequences is 15 kHz. The difference value between the number of subcarriers of the sub-band corresponding to each first sequence of the four first sequences and the number of pieces of data contained in the first sequence is an even number 4. DFT is performed on each first sequence of the four first sequences to obtain four second sequences. Two pieces of data 0 are added to both ends of each second sequence of the four second sequences respectively, to obtain four third sequences.

In some embodiments, performing the cyclic repetition on the second sequence to obtain the third sequence, includes: determining a difference value Q between the number of subcarriers of the sub-band corresponding to the first sequence and the number of pieces of data included in the first sequence; in a case where Q is an even number, cyclically repeating Q/2 pieces of data at both ends of the second sequence, to obtain the third sequence; in a case where Q is an odd number, cyclically repeating (Q+1)/2 pieces of data at a head end of the second sequence and cyclically repeating (Q−1)/2 pieces of data at a tail end of the second sequence, to obtain the third sequence; or cyclically repeating (Q−1)/2 pieces of data at a head end of the second sequence and cyclically repeating (Q+1)/2 pieces of data at a tail end of the second sequence, to obtain the third sequence.

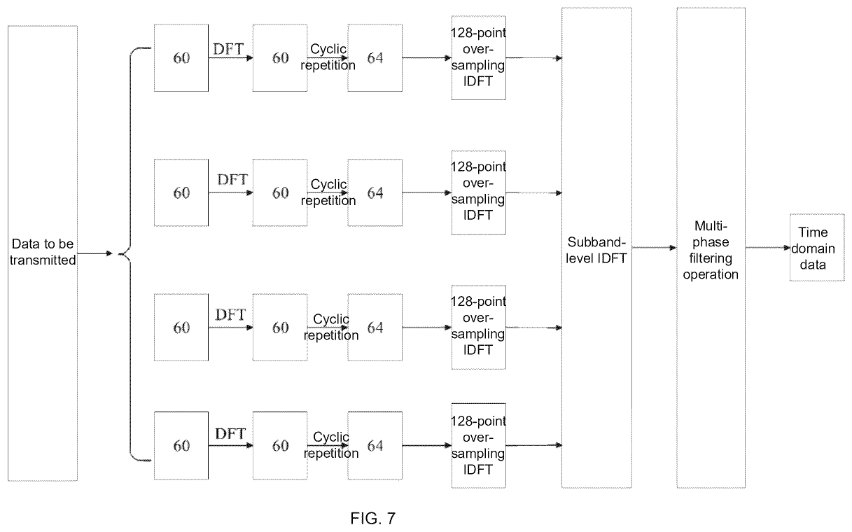

Exemplarily, as shown in FIG. 7, the data to be transmitted is divided into four first sequences, and each of the first sequences contains 60 pieces of data. The number of subcarriers of the sub-band corresponding to each first sequence of the four first sequences is 64, and the subcarrier spacing of the sub-band corresponding to each first sequence of the four first sequences is 15 kHz. The difference value between the number of subcarriers of the sub-band corresponding to each first sequence and the number of pieces of data contained in the first sequence is 4. Therefore, DFT is performed on the four first sequences respectively, to obtain four second sequences; and two pieces of data are cyclically repeated at both ends of the four second sequences respectively, to obtain four third sequences. For example, it is assumed that DFT is performed on the 1st first sequence to obtain a second sequence [x1 x2 x3 . . . x59 x60]. Then, two pieces of data are repeated cyclically at both ends of the second sequence respectively, to obtain a third sequence corresponding to the 1st first sequence, which is [x59 x60 x1 x2 x3 . . . x59 x60 x1 x2].

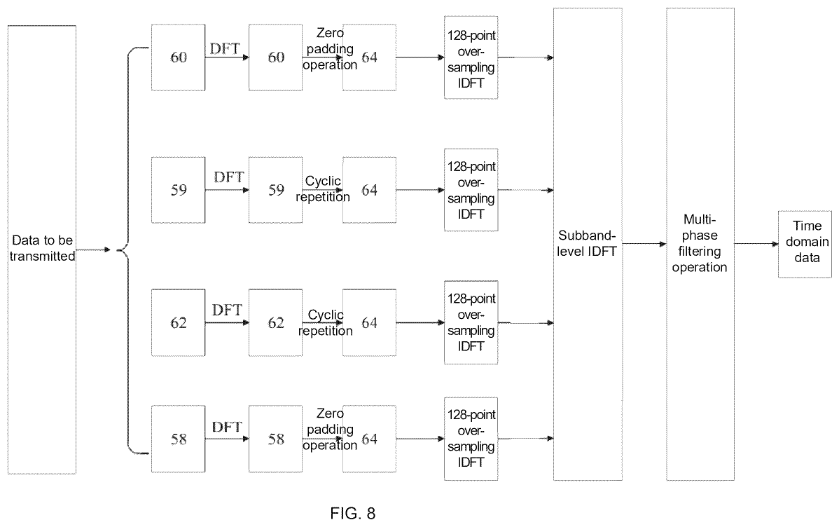

Yet exemplarily, as shown in FIG. 8, the data to be transmitted is divided into four first sequences, where the 1st first sequence contains 60 pieces of data, and the 2nd first sequence contains 59 data, the 3rd first sequence contains 62 pieces of data, and the 4th first sequence contains 58 pieces of data. The number of subcarriers of the sub-band corresponding to each first sequence of the four first sequences is 64, and the subcarrier spacing of the sub-band corresponding to each first sequence of the four first sequences is 15 kHz. DFT is performed on each first sequence of the four first sequences respectively, to obtain four second sequences. Then, the zero padding operation is performed on the second sequences corresponding to the 1st first sequence and the 4th first sequence respectively, to obtain the third sequences corresponding to the 1st first sequence and the 4th first sequence respectively; the cyclic repetition operation is performed on the second sequences corresponding to the 2nd first sequence and the 3rd first sequence respectively, to obtain the third sequences corresponding to the 2nd first sequence and the 3rd first sequence respectively.

For example, assuming that the second sequence obtained by performing DFT on the 1st first sequence is [x1 x2 x3 . . . x59 x60], then the third sequence obtained by performing the zero padding operation on the second sequence is [0 0 x1 x2 x3 . . . x59 x60 0 0]; assuming that the second sequence obtained by performing DFT on the 4th first sequence is [x1 x2 x3 . . . x57 x58], then the third sequence obtained by performing the zero padding operation on the second sequence is [0 0 0 x1 x2 x3 . . . x57 x58 0 0 0]; assuming that the second sequence obtained by performing DFT on the 2nd first sequence is [x1 x2 x3 . . . x59], then the third sequence obtained by performing the cyclic repetition on the second sequence is [x57 x58 x59 x1 x2 x3 . . . x59 x1 x2]; assuming that the second sequence obtained by performing DFT on the 3rd first sequence is [x1 x2 x3 . . . x61 x62], then the third sequence obtained by performing the cyclic repetition on the second sequence is [x62 x1 x2 x3 . . . x61 x62 x1].

In some embodiments, for a first sequence with a number of pieces of data equal to a number of subcarriers of a corresponding sub-band, the first sequence is used as the third sequence, or a Fourier transform is performed on the first sequence to obtain the third sequence. In this way, for a sub-band without the super-Nyquist transmission, single-carrier or multi-carrier data may be selected.

Exemplarily, continuing to refer to FIG. 3, each first sequence of 2nd, 3rd, and 4th first sequences contains 64 pieces of data, and the numbers of subcarriers of the corresponding sub-bands are all 64. DFT is performed on each first sequence of the 2nd and 4th first sequences to obtain a third sequence corresponding to each first sequence of the 2nd and 4th first sequences. The 3rd first sequence is used as a third sequence corresponding to the 3rd first sequence.

S103, obtain a data sequence based on the N third sequences.

In some embodiments, a first inverse Fourier transform is performed on the N third sequences, to obtain N fourth sequences; a second inverse Fourier transform is performed on the N fourth sequences, to obtain a data sequence. The inverse Fourier transform (inverse fourier transform, IFT) is an inverse operation of the Fourier transform, which converts a signal in the frequency domain back to the time domain. Exemplarily, the inverse Fourier transform is an inverse discrete Fourier transform (inverse discrete fourier transform, IDFT).

In some embodiments, a number of sampling points of the first inverse Fourier transform performed on each third sequence of the N third sequences is the same as a number of subcarriers of a sub-band corresponding to the third sequence. Since information of the third sequence comes from the first sequence, the sub-band corresponding to the third sequence is the same as the sub-band corresponding to the first sequence corresponding to the third sequence.

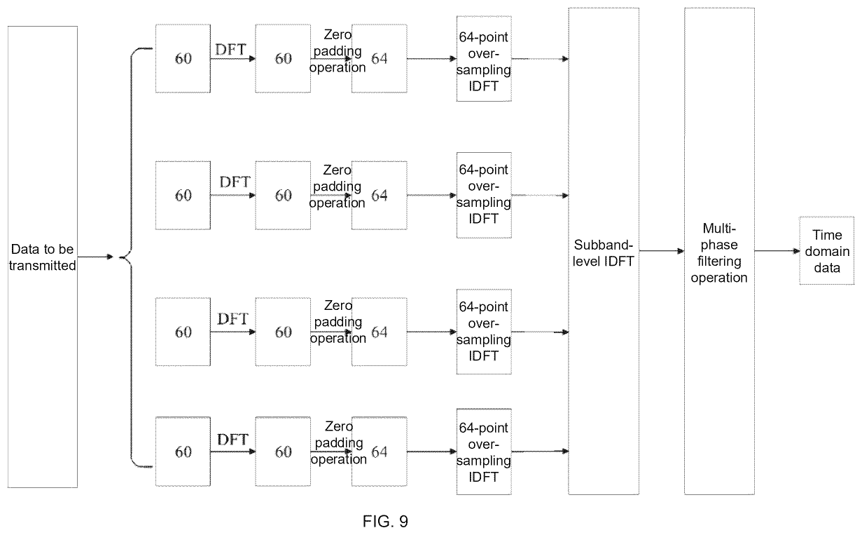

Exemplarily, as shown in FIG. 9, the data to be transmitted is divided into four first sequences, and each of the first sequences contains 60 pieces of data. The number of subcarriers of a sub-band corresponding to each first sequence of the four first sequences is 64, and the subcarrier spacing of a sub-band corresponding to each first sequence of the four first sequences is 15 kHz. DFT and then the zero padding operation are performed on the four first sequences in the figure, to obtain four third sequences, and each of the third sequences contains 64 pieces of data; the first inverse Fourier transform is performed on the four third sequences respectively, to obtain four fourth sequences; and the second inverse Fourier transform is performed on the four fourth sequences, to obtain a data sequence. The number of sampling points of the first inverse Fourier transform performed on each third sequence of the four third sequences is 64, which is the same as the number of subcarriers of its corresponding sub-band.

In some embodiments, the first inverse Fourier transform performed on each third sequence of the N third sequences is a P-times of an oversampled inverse Fourier transform, and a number of sampling points of the first inverse Fourier transform is a product of a number of subcarriers of a sub-band corresponding to the third sequence and P, where P is an integer greater than or equal to 2.

Exemplarily, continuing to refer to FIG. 8, the number of subcarriers of the sub-band corresponding to each third sequence is 64, and the subcarrier spacing of the sub-band corresponding to each third sequence is 15 kHz. The first inverse Fourier transform performed on each third sequence of the four third sequences is 2-times of the oversampled IDFT, and the number of sampling points of the first inverse Fourier transform is 128.

In some embodiments, a number of sampling points of the first inverse Fourier transform performed on each third sequence of the N third sequences is the same.

Exemplarily, continuing to refer to FIG. 3, the data to be transmitted is divided into four first sequences, and the number of subcarriers of the sub-band corresponding to each first sequence of the four first sequences is 64, and the subcarrier spacing of the sub-band corresponding to each first sequence of the four first sequences is 15 kHz. The first inverse Fourier transform is performed on each third sequence of the four third sequences corresponding to the four first sequences in the figure, to obtain four fourth sequences; and the second inverse Fourier transform is performed on the four fourth sequences respectively to obtain a data sequence. The first inverse Fourier transform performed on each third sequence of the four third sequences in the figure respectively is two-times of the oversampled IDFT, and the number of sampling points of the first inverse Fourier transform is 128.

In some embodiments, a number of sampling points of the first inverse Fourier transform performed on each third sequence of the N third sequences is not all the same; numbers of sampling points of first inverse Fourier transforms performed on respective third sequences corresponding to two sub-bands with a same subcarrier spacing are the same; and numbers of sampling points of first inverse Fourier transforms performed on respective third sequences corresponding to two sub-bands with different subcarrier spacings are different.

Exemplarily, continuing to refer to FIG. 6, the numbers of subcarriers of the sub-bands corresponding to the 1st and 2nd first sequences in the figure are 32 respectively, and the subcarrier spacings are both 30 kHz. The numbers of subcarriers of the sub-bands corresponding to the 3rd and 4th first sequences are 64 respectively, and the subcarrier spacings are both 15 kHz. DFT is performed on these four first sequences respectively to obtain four second sequences; the zero padding operation is performed on the four second sequences respectively to obtain four third sequences. The numbers of pieces of data contained in the third sequences corresponding to the 1st and 2nd first sequences are 32, and the numbers of pieces of data contained in the third sequences corresponding to the 3rd and 4th first sequences are 64. For example, assuming that the second sequence obtained by performing DFT on the 1st first sequence is [x1 x2 x3 . . . x29 x30], then the third sequence obtained by performing the zero padding operation is [0 x1 x2 x3 . . . x29 x30 0].

Then, the first inverse Fourier transform is performed on the four third sequences respectively, to obtain four fourth sequences; the second inverse Fourier transform is performed on the four fourth sequences respectively, to obtain a data sequence. The first inverse Fourier transforms respectively performed on the third sequences corresponding to the 1st and 2nd first sequences are both two-times of the oversampled inverse Fourier transform with the number of sampling points of 64. The first inverse Fourier transforms respectively performed on the third sequences corresponding to the 3rd and 4th first sequences are both two-times of the oversampled IDFT with the number of sampling points of 128.

In some embodiments, zero frequency positions of first inverse Fourier transforms performed on different third sequences are different.

In some embodiments, a number of sampling points of the first inverse Fourier transform is less than a sum of numbers of subcarriers of respective sub-bands corresponding to the N first sequences. A zero frequency position of the first inverse Fourier transform performed on the third sequence is located within a frequency domain range of the corresponding sub-band.

In some embodiments, the zero frequency position of the first inverse Fourier transform performed on the third sequence is a subcarrier among subcarriers of the corresponding sub-band.

In some embodiments, the N fourth sequences are multiplied by corresponding coefficient groups respectively, to obtain N fifth sequences; and the second inverse Fourier transform is performed on the N fifth sequences, to obtain a data sequence.

In some embodiments, the coefficient group is: [exp(2πi/M×(n−1)×0), exp(2πi/M×(n−1)×1), . . . exp(2πi/M×(n−1)×(M×k(n)−1))], or [exp(2πi/M×(n−1)×0+πi)exp(2πi/M×(n−1)×1+πi), . . . , exp(2πi/M×(n−1)×(M×k(n)−1)+πi)]. k(n) is the number of pieces of data contained in the n-th first sequence of the N first sequences, n is a positive integer less than or equal to N, and k(n) is a positive integer.

In some embodiments, the second inverse Fourier transform process is that: for sub-bands with different subcarrier spacings, a length of a fourth sequence corresponding to a sub-band with the smallest subcarrier spacing is used as a reference length; for fourth sequences corresponding to sub-bands with non-minimum subcarrier spacings, they are cascaded into a sequence with a same length as the reference length, which then together with the fourth sequence corresponding to the sub-band with the minimum subcarrier spacing, constitutes N seventh sequences; and multiple inverse Fourier transforms are performed on the N seventh sequences, to obtain a data sequence.

Exemplarily, continuing to refer to FIG. 6, the four third sequences correspond to sub-bands with different subcarrier spacings, subcarrier spacings of sub-bands corresponding to the 1st and 2nd first sequences are 30 kHz, and subcarrier spacings of sub-bands corresponding to the 3rd and 4th first sequences are 15 kHz. Using the fourth sequences corresponding to the 3rd and 4th first sequences as the reference length, next moment symbol data and current moment symbol data of the fourth sequences corresponding to the 1st and 2nd first sequences are cascaded together to form 128-point sequences, which then together with the fourth sequences corresponding to the 3rd and 4th first sequences, constitutes four seventh sequences; and multiple inverse Fourier transforms are performed on the four seventh sequences, to obtain a data sequence.

In other embodiments, the second inverse Fourier transform process is to: arrange the N fourth sequences by rows to obtain a data matrix; extract K sixth sequences from the data matrix by columns, where the sixth sequence includes N pieces of data, and K is a positive integer; perform an oversampled inverse Fourier transformation on the K sixth sequences respectively, to obtain K time domain sequences; and cascade the K time domain sequences to obtain a data sequence.

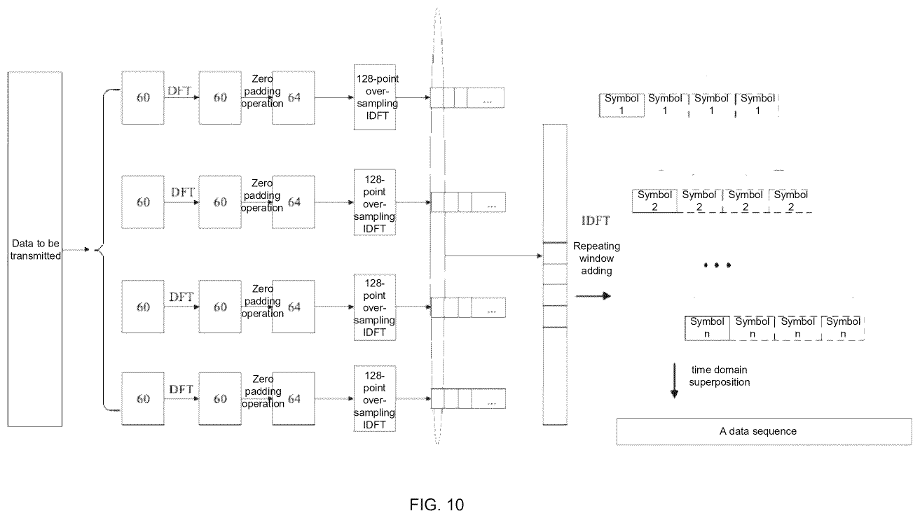

Exemplarily, as shown in FIG. 10, the data to be transmitted is divided into 4 first sequences, and each of the first sequences contains 60 pieces of data. The subcarrier spacing of a sub-band corresponding to each first sequence is 15 kHz. DFT is performed on each first sequence respectively, to obtain four second sequences; then the zero padding operation is performed on both ends of each second sequence of the four second sequences, to obtain four third sequences, where each of the third sequences contains 64 pieces of data. For example, a second sequence obtained from the 1st first sequence through DFT is: [x1 x2 x3 . . . x59 x60], and then a third sequence obtained through the zero padding operation is: [0 0 x1 x2 x3 . . . x59 x 60 0 0]. The first inverse Fourier transform is performed on the four third sequences respectively, to obtain four fourth sequences. The first inverse Fourier transform is two-times of the oversampled IDFT with 128 points.

Then, the second inverse Fourier transform is performed on the four fourth sequences, and the second inverse Fourier transform process is to: arrange the four fourth sequences by rows to obtain a 4-row data matrix; extract K sixth sequences from the data matrix by columns, where the sixth sequence includes four pieces of data and K is a positive integer; perform the oversampled inverse Fourier transform with 16 points on the K sixth sequences respectively, to obtain K sub-symbols, then repeatedly extend the K sub-symbols respectively four times, to obtain K time domain sequences; and finally, cascade the K time domain sequences to obtain a data sequence, where the data sequence contains 128 sub-symbols. The interval of the cascading is 8 points, which is half the length of a sub-symbol.

In some embodiments, the second inverse Fourier transform is performed on the N fourth sequences and the K eighth sequences, to obtain a data sequence, where the K eighth sequences are sequences generated based on data other than the data to be transmitted, and K is a positive integer.

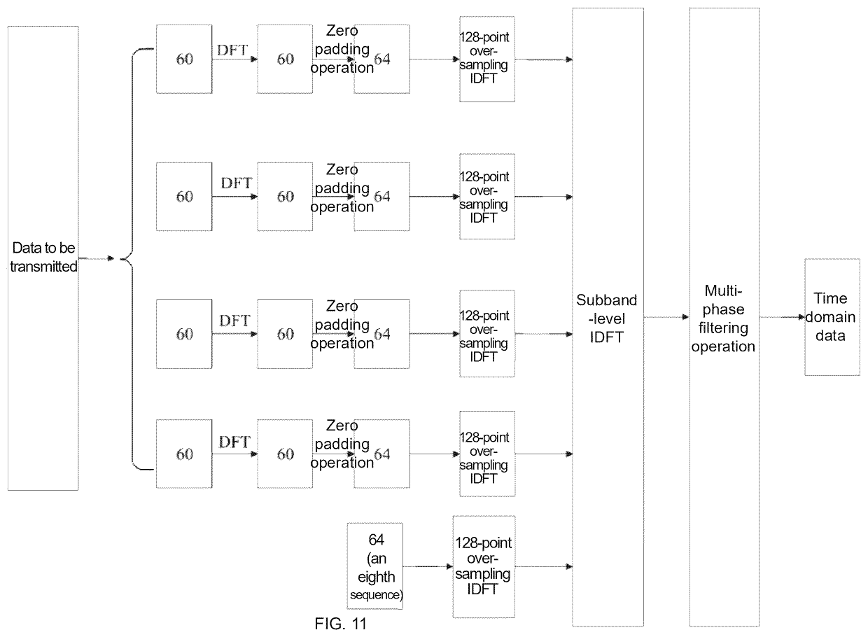

Exemplarily, as shown in FIG. 11, the data to be transmitted is divided into 4 first sequences, and each of the first sequences contains 60 pieces of data. The number of subcarriers of a sub-band corresponding to each first sequence of the four first sequences is 64, and the subcarrier spacing of a sub-band corresponding to each first sequence of the four first sequences is 15 kHz. DFT and then the zero padding operation are performed on the four first sequences in the figure, to obtain four third sequences, and each of the third sequences contains 64 pieces of data. The first inverse Fourier transform is performed on the four third sequences and an eighth sequence respectively, to obtain five fourth sequences, where the eighth sequence contains 64 pieces of data; and the second inverse Fourier transform is performed on the five fourth sequences together, to form a data sequence. The eighth sequence contains 64 pieces of data, and does not belong to data sequences generated from the data to be transmitted.

S104, transmit the data sequence on a time-frequency resource corresponding to the data to be transmitted.

In some embodiments, a time domain data sequence on which a window adding operation has been performed, is transmitted on the time-frequency resource corresponding to the data to be transmitted.

In some embodiments, a time domain data sequence on which filtering has been performed, is transmitted on the time-frequency resource corresponding to the data to be transmitted.

In some embodiments, the filtering is single-phase filtering or multi-phase filtering. For example, referring to FIG. 3 to FIG. 9 and FIG. 11, a data sequence on which the multi-phase filtering has been performed, is transmitted on the time-frequency resource corresponding to the data to be transmitted.

In some embodiments, filtering functions used for the multi-phase filtering include: a root raised cosine function, or a raised cosine function, or a rectangular function, or an IOTA function, etc.

Based on these, the Fourier transform, and then the cyclic repetition or zero padding operation is performed on each first sequence of M first sequences with the number of pieces of data less than the number of subcarriers of the corresponding sub-band, among N first sequences, to enable that the number of pieces of data is equal to the number of subcarriers of the corresponding sub-band, thereby reducing out-of-band leakage, reducing guard intervals, and improving frequency spectrum efficiency. This is also conducive to flexibly configuring the number of pieces of data within the sub-band.

The above introduces the solutions of the embodiments of the present disclosure mainly from the perspective of the methods. A data transmission apparatus is also illustrated below, for performing the data transmission method in any of the above embodiments and implementations thereof. It can be understood that the data transmission apparatus includes the corresponding hardware structures and/or software modules for performing the respective functions, to implement the data transmission method; and those skilled in the art should easily recognize that the present disclosure can be implemented in the form of hardware or a combination of hardware and computer software, in conjunction with the algorithmic steps of the respective examples described in the embodiments of the present disclosure. Whether a certain function is performed by hardware or computer software-driven hardware depends on the specific application and design constraints of the technical solutions. Professional technicians may use different methods to implement the described functions, for each specific application, but such an implementation should not be considered beyond the scope of the present disclosure.

In the embodiments of the present disclosure, the data transmission apparatus may be divided into functional modules according to the above-mentioned method embodiments, and for example, each functional module may be divided corresponding to each function, or two or more functions may be integrated into one functional module. The above-mentioned integrated module may be implemented in the form of hardware or may be implemented in the form of software. It should be noted that the division of modules in the embodiments of the present disclosure is illustrative, and is merely a kind of logical functional division, and there may be other division methods in actual implementations. The example in which each functional module may be divided corresponding to each function is taken for explanation below.

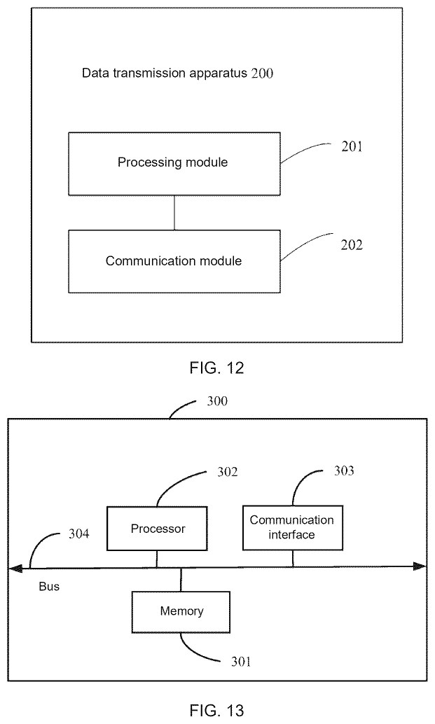

FIG. 12 shows a data transmission apparatus provided in the embodiments of the present disclosure, which is applicable to a first communication node. The data transmission apparatus 200 includes: a processing module 201 and a communication module 202.

The processing module 201 is configured to divide data to be transmitted into N first sequences; where the N first sequences correspond to different sub-bands, a number of pieces of data of each of M first sequences in the N first sequences is less than a number of subcarriers of a corresponding sub-band, N is a positive integer, and M is a positive integer less than or equal to N.

The processing module 201 is further configured to obtain N third sequences based on the N first sequences; where M third sequences in the N third sequences are obtained by performing a Fourier transform, and then performing a cyclic repetition or zero padding operation on the M first sequences, respectively; a number of pieces of data of each of the N third sequences is equal to a number of subcarriers of a corresponding sub-band.

The processing module 201 is further configured to obtain a data sequence based on the N third sequences.

The communication module 202 is configured to transmit the data sequence on a time-frequency resource corresponding to the data to be transmitted.

In some embodiments, the processing module 201 is further configured to: for a first sequence with a number of pieces of data less than a number of subcarriers of a corresponding sub-band and in the N first sequences, perform a Fourier transform on the first sequence to obtain a second sequence; and perform a cyclic repetition or zero padding operation on the second sequence to obtain a third sequence in the N third sequences.

In some embodiments, the processing module 201 may be configured to: determine a difference value Q between the number of subcarriers of the sub-band corresponding to the first sequence and the number of pieces of data included in the first sequence; in a case where Q is an even number, cyclically repeat Q/2 pieces of data at both ends of the second sequence, to obtain the third sequence; in a case where Q is an odd number, cyclically repeat (Q+1)/2 pieces of data at a head end of the second sequence and cyclically repeat (Q−1)/2 pieces of data at a tail end of the second sequence, to obtain the third sequence; or cyclically repeat (Q−1)/2 pieces of data at a head end of the second sequence and cyclically repeat (Q+1)/2 pieces of data at a tail end of the second sequence, to obtain the third sequence.

In some embodiments, the processing module 201 may be configured to: determine a difference value Q between the number of subcarriers of the sub-band corresponding to the first sequence and the number of pieces of data included in the first sequence; in a case where Q is an even number, add Q/2 pieces of zero data to both ends of the second sequence, to obtain the third sequence; in a case where Q is an odd number, add (Q+1)/2 pieces of zero data to a head end of the second sequence and add (Q−1)/2 pieces of zero data to a tail end of the second sequence, to obtain the third sequence; or add (Q−1)/2 pieces of zero data to a head end of the second sequence and add (Q+1)/2 pieces of zero data to a tail end of the second sequence, to obtain the third sequence.

In some embodiments, the processing module 201 is further configured to: for a first sequence with a number of pieces of data equal to a number of subcarriers of a corresponding sub-band and in the N first sequences, use the first sequence as a third sequence in the N third sequences, or perform a Fourier transform on the first sequence to obtain a third sequence in the N third sequences.

In some embodiments, a number of pieces of data of each of the N first sequences is less than a number of subcarriers of a corresponding sub-band.

In some embodiments, numbers of pieces of data of the M first sequences are all the same; or numbers of pieces of data of the M first sequences are not all the same.

In some embodiments, the N first sequences are all transmitted in a single carrier mode.

In some embodiments, the M first sequences are transmitted in a single carrier mode, and other N-M first sequences except for the M first sequences in the N first sequences are transmitted in a multi-carrier mode.

In some embodiments, numbers of subcarriers of sub-bands corresponding to the N first sequences are the same, and subcarrier spacings of sub-bands corresponding to the N first sequences are the same.

In some embodiments, numbers of subcarriers of sub-bands corresponding to the N first sequences are not all the same; where subcarrier spacings of two sub-bands with a same number of subcarriers are the same; and subcarrier spacings of two sub-bands with different numbers of subcarriers are different.

In some embodiments, for the two sub-bands with different numbers of subcarriers, a ratio value between the numbers of subcarriers of the two sub-bands is 2 to a power of i, and a ratio value between the subcarrier spacings of the two sub-bands is 2 to a power of −i, where i is an integer.

In some embodiments, the processing module 201 may be configured to: perform a first inverse Fourier transform on the N third sequences respectively, to obtain N fourth sequences; perform a second inverse Fourier transform on the N fourth sequences, to obtain the data sequence, where a number of sampling points of the second inverse Fourier transform is greater than N.

In some embodiments, a number of sampling points of the first inverse Fourier transform performed on each third sequence of the N third sequences is the same as a number of subcarriers of a sub-band corresponding to the third sequence.

In some embodiments, the first inverse Fourier transform performed on each third sequence of the N third sequences is P-times of an oversampled inverse Fourier transform, and a number of sampling points of the first inverse Fourier transform is a product of a number of subcarriers of a sub-band corresponding to the third sequence and P, where P is an integer greater than or equal to 2.

In some embodiments, a number of sampling points of the first inverse Fourier transform performed on each third sequence of the N third sequences is the same.

In some embodiments, a number of sampling points of the first inverse Fourier transform performed on each third sequence of the N third sequences is not all the same. Numbers of sampling points of first inverse Fourier transforms performed on respective third sequences corresponding to two sub-bands with a same subcarrier spacing are the same; and numbers of sampling points of first inverse Fourier transforms performed on respective third sequences corresponding to two sub-bands with different subcarrier spacings are different.

In some embodiments, a number of sampling points of the first inverse Fourier transform is less than a sum of numbers of subcarriers of respective sub-bands corresponding to the N first sequences.

In some embodiments, zero frequency positions of first inverse Fourier transforms performed on different third sequences are different.

In some embodiments, a zero frequency position of the first inverse Fourier transform performed on the third sequence is located within a frequency domain range of the corresponding sub-band.

In some embodiments, the zero frequency position of the first inverse Fourier transform performed on the third sequence is a subcarrier among subcarriers of the corresponding sub-band.

In some embodiments, the processing module 201 may be configured to: multiply the N fourth sequences by corresponding coefficient groups respectively, to obtain N fifth sequences; perform the second inverse Fourier transform on the N fifth sequences, to obtain the data sequence.

In some embodiments, the processing module 201 may be configured to: arrange the N fourth sequences by rows to obtain a data matrix; extract K sixth sequences from the data matrix by columns, where the sixth sequence includes N pieces of data, and K is a positive integer; perform an oversampled inverse Fourier transformation on the K sixth sequences respectively, to obtain K time domain sequences; cascade the K time domain sequences to obtain the data sequence.

In some embodiments, the processing module 201 may be configured to: perform the second inverse Fourier transform on the N fourth sequences and K eighth sequences to obtain the data sequence, where the K eighth sequences are sequences generated based on data other than the data to be transmitted, and K is a positive integer.

In some embodiments, the data to be transmitted includes constellation point modulated data and R pieces of reference signal data, where R is a positive integer.

In some embodiments, the data to be transmitted is all or a part of data to be transmitted in a channel bandwidth.

In some embodiments, N sub-bands include all or part of frequency domain resources in a channel bandwidth, and each sub-band of the N sub-bands corresponds to a first sequence.

In a case of implementing the functions of the integrated modules mentioned above in the form of hardware, the embodiments of the present disclosure further provide a structure of a communication apparatus, and the communication apparatus is configured to perform the data transmission method provided by the embodiments of the present disclosure. As shown in FIG. 13, the communication apparatus 300 includes a communication interface 303, a processor 302, and a bus 304. In some embodiments, the communication apparatus may further include a memory 301.

The processor 302 may implement or perform various exemplary logical blocks, modules and circuits described in conjunction with the embodiments of the present disclosure. The processor 302 may be a central processing unit, a general-purpose processor, a digital signal processor, an application specific integrated circuit, a field programmable gate array or other programmable logic devices, a transistor logic device, a hardware component or any combination thereof, which may implement or perform various exemplary logical blocks, modules and circuits described in conjunction with the embodiments of the present disclosure. The processor 302 may also be a combination that implements computing functions, for example, including a combination of one or more microprocessors, a combination of a digital signal processor (DSP) and a microprocessor, or the like.

The communication interface 303 is configured to connect with other devices via a communication network. The communication network may be an Ethernet, a radio access network, a wireless local area network (WLAN), or the like.

The memory 301 may be, but be not limited to, a read-only memory (ROM) or other types of static storage devices capable of storing static information and instructions, a random access memory (RAM) or other types of dynamic storage devices capable of storing information and instructions, or may also be an electrically erasable programmable read-only memory (EEPROM), a magnetic disk storage medium or other magnetic storage devices, or any other medium capable of being used to carry or store the desired program codes in the form of instructions or data structures and capable of being accessed by a computer.

As an implementation, the memory 301 may exist independently of the processor 302, and the memory 301 may be connected to the processor 302 via the bus 304 and used for storing instructions or program codes. The processor 302, when calling and executing the instructions or program codes stored in the memory 301, is capable of implementing the data transmission method provided by the embodiments of the present disclosure.

In another implementation, the memory 301 may also be integrated with the processor 302.

The bus 304 may be an extended industry standard architecture (EISA) bus or the like. Buses 304 may be divided into address buses, data buses, control buses, and the like. For the convenience of representation, only one thick line is used in FIG. 13 for representation, but it does not mean that there is only one bus or one type of bus.

Some embodiments of the present disclosure provide a computer-readable storage medium (e.g., a non-transitory computer-readable storage medium), and the computer-readable storage medium has stored computer program instructions therein that, when running on a computer, cause the computer to perform the data transmission method as described in any of the above-mentioned embodiments.

In an exemplary implementation, the computer may be the above-mentioned data transmission apparatus, and the present disclosure does not limit the specific form of the computer.

In some examples, the above-mentioned computer-readable storage medium may include, but be not limited to, a magnetic storage device (e.g., a hard disk, a floppy disk or a magnetic tape, etc.), an optical disk (e.g., a Compact Disk (CD) or a Digital Versatile Disk (DVD), etc.), a smart card and a flash memory device (e.g., an Erasable Programmable Read-Only Memory (EPROM), a card, a stick or a key driver, etc.). The various computer-readable storage media described in the present disclosure may represent one or more devices and/or other machine-readable storage media for storing information. The term “machine-readable storage medium” may include, but be not limited to, a radio channel and various other media capable of storing, containing, and/or carrying instructions and/or data.

The embodiments of the present disclosure provide a computer program product including instructions, and the computer program product, when running on a computer, causes the computer to perform the data transmission method as described in any embodiment of the above-mentioned embodiments.

The foregoing is only the specific implementations of the present disclosure, but the protection scope of the present disclosure is not limited thereto, and any changes or substitutions within the scope of the technologies disclosed in the present disclosure should be covered within the protection scope of the present disclosure. Therefore, the protection scope of the present disclosure should be based on the protection scope of claims.

What is claimed is:

1. A data transmission method, wherein the method comprises:
dividing data to be transmitted into N first sequences; wherein the N first sequences correspond to different sub-bands, a number of pieces of data of each of M first sequences in the N first sequences is less than a number of subcarriers of a corresponding sub-band, N is a positive integer, and M is a positive integer less than or equal to N;
obtaining N third sequences based on the N first sequences; wherein M third sequences in the N third sequences are obtained by performing a Fourier transform, and then performing a cyclic repetition or zero padding operation on the M first sequences, respectively; a number of pieces of data of each of the N third sequences is equal to a number of subcarriers of a corresponding sub-band;
obtaining a data sequence based on the N third sequences;
transmitting the data sequence on a time-frequency resource corresponding to the data to be transmitted.

2. The method according to claim 1, wherein obtaining the N third sequences based on the N first sequences, comprises:
for a first sequence with a number of pieces of data less than a number of subcarriers of a corresponding sub-band and in the N first sequences, a Fourier transform is performed on the first sequence to obtain a second sequence; a cyclic repetition or zero padding operation is performed on the second sequence to obtain a third sequence in the N third sequences.

3. The method according to claim 2, wherein
performing the cyclic repetition on the second sequence to obtain the third sequence, comprises:
determining a difference value Q between the number of subcarriers of the sub-band corresponding to the first sequence and the number of pieces of data comprised in the first sequence;
in a case where Q is an even number, cyclically repeating Q/2 pieces of data at both ends of the second sequence, to obtain the third sequence;
in a case where Q is an odd number, cyclically repeating (Q+1)/2 pieces of data at a head end of the second sequence and cyclically repeating (Q−1)/2 pieces of data at a tail end of the second sequence, to obtain the third sequence; or cyclically repeating (Q−1)/2 pieces of data at a head end of the second sequence and cyclically repeating (Q+1)/2 pieces of data at a tail end of the second sequence, to obtain the third sequence; or
performing the zero padding operation on the second sequence to obtain the third sequence, comprises:
determining a difference value Q between the number of subcarriers of the sub-band corresponding to the first sequence and the number of pieces of data comprised in the first sequence;
in a case where Q is an even number, adding Q/2 pieces of zero data to both ends of the second sequence, to obtain the third sequence;
in a case where Q is an odd number, adding (Q+1)/2 pieces of zero data to a head end of the second sequence and adding (Q−1)/2 pieces of zero data to a tail end of the second sequence, to obtain the third sequence; or adding (Q−1)/2 pieces of zero data to a head end of the second sequence and adding (Q+1)/2 pieces of zero data to a tail end of the second sequence, to obtain the third sequence.

4. (canceled)

5. The method according to claim 2, wherein obtaining the N third sequences based on the N first sequences, further comprises:
for a first sequence with a number of pieces of data equal to a number of subcarriers of a corresponding sub-band and in the N first sequences, the first sequence is used as a third sequence in the N third sequences, or a Fourier transform is performed on the first sequence to obtain a third sequence in the N third sequences.

6. The method according to claim 1, wherein a number of pieces of data of each of the N first sequences is less than a number of subcarriers of a corresponding sub-band.

7. The method according to claim 1, wherein numbers of pieces of data of the M first sequences are all the same; or numbers of pieces of data of the M first sequences are not all the same.

8. The method according to claim 1, wherein the N first sequences are all transmitted in a single carrier mode; or
the M first sequences are transmitted in a single carrier mode, and other N-M first sequences except for the M first sequences in the N first sequences are transmitted in a multi-carrier mode.

9. (canceled)

10. The method according to claim 1, wherein numbers of subcarriers of sub-bands corresponding to the N first sequences are the same, and subcarrier spacings of sub-bands corresponding to the N first sequences are the same; or
numbers of subcarriers of sub-bands corresponding to the N first sequences are not all the same; wherein subcarrier spacings of two sub-bands with a same number of subcarriers are the same; and subcarrier spacings of two sub-bands with different numbers of subcarriers are different.

11. (canceled)

12. The method according to claim 10, wherein for the two sub-bands with different numbers of subcarriers, a ratio value between the numbers of subcarriers of the two sub-bands is 2 to a power of i, and a ratio value between the subcarrier spacings of the two sub-bands is 2 to a power of −i, wherein i is an integer.

13. The method according to claim 1, wherein obtaining the data sequence based on the N third sequences, comprises:
performing a first inverse Fourier transform on the N third sequences respectively, to obtain N fourth sequences;
performing a second inverse Fourier transform on the N fourth sequences, to obtain the data sequence, wherein a number of sampling points of the second inverse Fourier transform is greater than N.

14. The method according to claim 13, wherein a number of sampling points of the first inverse Fourier transform performed on each third sequence of the N third sequences is the same as a number of subcarriers of a sub-band corresponding to the third sequence; or
the first inverse Fourier transform performed on each third sequence of the N third sequences is P-times of an oversampled inverse Fourier transform, and a number of sampling points of the first inverse Fourier transform is a product of a number of subcarriers of a sub-band corresponding to the third sequence and P, wherein P is an integer greater than or equal to 2; or
a number of sampling points of the first inverse Fourier transform performed on each third sequence of the N third sequences is the same; or
a number of sampling points of the first inverse Fourier transform performed on each third sequence of the N third sequences is not all the same; numbers of sampling points of first inverse Fourier transforms performed on respective third sequences corresponding to two sub-bands with a same subcarrier spacing are the same; and numbers of sampling points of first inverse Fourier transforms performed on respective third sequences corresponding to two sub-bands with different subcarrier spacings are different; or
a number of sampling points of the first inverse Fourier transform is less than a sum of numbers of subcarriers of respective sub-bands corresponding to the N first sequences; or
zero frequency positions of first inverse Fourier transforms performed on different third sequences are different.

15-19. (canceled)

20. The method according to claim 13, wherein a zero frequency position of the first inverse Fourier transform performed on the third sequence is located within a frequency domain range of the corresponding sub-band.

21. The method according to claim 20, wherein the zero frequency position of the first inverse Fourier transform performed on the third sequence is a subcarrier among subcarriers of the corresponding sub-band.

22. The method according to claim 13, wherein performing the second inverse Fourier transform on the N fourth sequences, to obtain the data sequence, comprises:
multiplying the N fourth sequences by corresponding coefficient groups respectively, to obtain N fifth sequences;
performing the second inverse Fourier transform on the N fifth sequences, to obtain the data sequence.

23. The method according to claim 13, wherein performing the second inverse Fourier transform on the N fourth sequences, to obtain the data sequence, comprises:
arranging the N fourth sequences by rows to obtain a data matrix;
extracting K sixth sequences from the data matrix by columns, wherein each of the sixth sequences comprises N pieces of data, and K is a positive integer;
performing an oversampled inverse Fourier transformation on the K sixth sequences respectively, to obtain K time domain sequences;
cascading the K time domain sequences to obtain the data sequence.

24. The method according to claim 13, wherein performing the second inverse Fourier transform on the N fourth sequences, to obtain the data sequence, comprises:
performing the second inverse Fourier transform on the N fourth sequences and K eighth sequences to obtain the data sequence, wherein the K eighth sequences are sequences generated based on data other than the data to be transmitted, and K is a positive integer.

25. The method according to claim 1, wherein the data to be transmitted comprises constellation point modulated data and R pieces of reference signal data, wherein R is a positive integer.

26. The method according to claim 1, wherein the data to be transmitted is all or a part of data to be transmitted in a channel bandwidth; or N sub-bands comprise all or part of frequency domain resources in a channel bandwidth, and each sub-band of the N sub-bands corresponds to a first sequence of the first sequences.

27. (canceled)

28. A communication apparatus, comprising: a memory and a processor; wherein the memory is coupled with the processor; the memory is configured to store instructions executable by the processor; the processor, when executing the instructions, performs a method comprising:
dividing data to be transmitted into N first sequences; wherein the N first sequences correspond to different sub-bands, a number of pieces of data of each of M first sequences in the N first sequences is less than a number of subcarriers of a corresponding sub-band, N is a positive integer, and M is a positive integer less than or equal to N;
obtaining N third sequences based on the N first sequences; wherein M third sequences in the N third sequences are obtained by performing a Fourier transform, and then performing a cyclic repetition or zero padding operation on the M first sequences, respectively; a number of pieces of data of each of the N third sequences is equal to a number of subcarriers of a corresponding sub-band;
obtaining a data sequence based on the N third sequences;
transmitting the data sequence on a time-frequency resource corresponding to the data to be transmitted.

29. A non-transitory computer-readable storage medium, wherein the computer-readable storage medium stores computer instructions, and the computer instructions, when executed on a communication apparatus, cause the communication apparatus to perform a method comprising:
dividing data to be transmitted into N first sequences; wherein the N first sequences correspond to different sub-bands, a number of pieces of data of each of M first sequences in the N first sequences is less than a number of subcarriers of a corresponding sub-band, N is a positive integer, and M is a positive integer less than or equal to N;
obtaining N third sequences based on the N first sequences; wherein M third sequences in the N third sequences are obtained by performing a Fourier transform, and then performing a cyclic repetition or zero padding operation on the M first sequences, respectively; a number of pieces of data of each of the N third sequences is equal to a number of subcarriers of a corresponding sub-band;
obtaining a data sequence based on the N third sequences;
transmitting the data sequence on a time-frequency resource corresponding to the data to be transmitted.
